(19) United States
(12) Patent Application Publication
(10) Pub. No.: US 2019/0264701 A1
(43) Pub. Date: Aug. 29, 2019

(54) GAS TURBINE ENGINE COMPRESSOR MANAGEMENT SYSTEM

(71) Applicant: ROLLS-ROYCE plc, London (GB)

(72) Inventor: Arthur L. ROWE, Derby (GB)

(73) Assignee: ROLLS-ROYCE plc, London (GB)

(21) Appl. No.: 16/272,156

(22) Filed: Feb. 11, 2019

(30) Foreign Application Priority Data
Feb. 27, 2018 (GB) 1803137.7

(51) Int. Cl. F04D 27/02; F02C 3/04

(52) U.S. Cl. CPC F04D 27/02; F02C 9/16; F02C 3/04

(57) ABSTRACT

A gas turbine engine compressor operating system for a gas turbine engine is disclosed. The gas turbine engine comprises a low pressure compressor and a high pressure compressor. The low and high pressure compressors are driven by low and high pressure shafts respectively, with the high pressure compressor being provided downstream in core mass flow of the low pressure compressor. The compressor operating system comprises a controller configured to control a variable geometry actuator of the low pressure compressor. The controller is configured to control the variable geometry actuator on the basis of low pressure compressor rotational speed (N1) and a high pressure compressor operating parameter such as one or more of core mass flow rate (\dot{m}), high pressure compressor pressure ratio (P30:P26), high pressure compressor rotational speed (N2), and high pressure compressor variable guide vane angle (α).

### CROSS-REFERENCE TO RELATED APPLICATIONS

This application is based upon and claims the benefit of priority from British Patent Application No. GB 1803137.7, filed on 27 Feb. 2018, the entire contents of which are incorporated by reference.

### BACKGROUND

### Technical Field

The present disclosure concerns a system for management of a gas turbine engine compressor.

### Description of the Related Art

Gas turbines typically comprise compressors of either an axial or a centrifugal type. In either case (though particularly for axial compressors), compressor variable geometry is desirable in order to allow the compressor to operate at a wide range of compressor rotational speeds, air mass flow rates and compressor loads.

Conventionally, compressor variable geometry comprises one or both of compressor bleeds and variable guide vanes (VGVs). Compressor bleeds allow a portion of air downstream of one or more compressor stages to be dumped overboard through a bleed valve, rather than passed to a downstream component, thereby reducing compressor pressure ratio. Similarly, variable guide vanes adjust the angle of oncoming air to a downstream rotor stage, to similarly reduce the compressor pressure ratio for a given rotational speed.

Compressor variable geometry is conventionally controlled on the basis of one or more compressor parameters such as pressure ratio, working gas flow temperature and/or compressor rotational speed. A “schedule” is used that relates a given sensed or calculated compressor parameter, and a corresponding desired variable geometry setting for that compressor. In many cases, different schedules are provided for different operating conditions, such as steady state and transient conditions.

### SUMMARY

According to a first aspect there is provided a gas turbine engine compressor operating system, the gas turbine engine comprising:

a low pressure compressor and a high pressure compressor, the low and high pressure compressors being driven by low and high pressure shafts respectively, the high pressure compressor being provided downstream in core mass flow of the low pressure compressor; the compressor operating system comprising:

a controller configured to control a variable geometry actuator of the low pressure compressor, the controller being configured to control the variable geometry actuator on the basis of low pressure compressor rotational speed and a high pressure compressor operating parameter.

Consequently, the low pressure compressor is controlled on the basis of both low pressure compressor speed and one or more high pressure compressor parameters.

The low pressure compressor rotational speed may comprise a corrected low pressure compressor rotational speed.

The high pressure compressor operating parameter may comprise one or more of high pressure compressor mass flow rate, high pressure compressor pressure ratio, high pressure compressor rotational speed, high pressure compressor corrected rotational speed and high pressure compressor variable inlet guide vane angle. The high pressure compressor operating parameter may comprise a parameter indicative of the high pressure compressor mass flow rate or pressure ratio.

The gas turbine engine may comprise a geared turbofan comprising a fan coupled to an output of a reduction gearbox. An input of the reduction gearbox may be coupled to the low pressure shaft, and a low pressure turbine may be coupled to the low pressure shaft.

The variable geometry actuator may comprise one or both of a variable inlet guide vane and a bleed valve.

The controller may be configured to operate the low pressure compressor on the basis of one of a first schedule and a second schedule in accordance with the high pressure compressor operating parameter. The low pressure compressor may be operated in accordance with the first schedule where the high pressure compressor is at a relatively low pressure ratio, and may be operated in accordance with the second schedule where the high pressure compressor is at a relatively high pressure ratio.

Where the actuator comprises a variable guide vane, the second schedule may comprise a more open inlet guide vane position for a given low pressure compressor rotational speed than the first schedule.

Where the variable geometry actuator comprises a bleed valve, the second schedule may comprise a more closed bleed valve position for a given low pressure compressor rotational speed than the first schedule.

Alternatively, the controller may be configured to determine a correction factor to the low pressure compressor control schedule based on the high pressure compressor parameter. The correction factor may be proportional to one or more of the high pressure compressor mass flow, the high pressure compressor pressure ratio, or a parameter indicative of the high pressure compressor pressure ratio.

According to a second aspect of the invention there is provided a method of controlling a gas turbine engine compressor of a gas turbine engine, the engine comprising:

a low pressure compressor and a high pressure compressor, the low and high pressure compressors being driven by low and high pressure shafts respectively, the high pressure compressor being provided downstream in core mass flow of the low pressure compressor; the method comprising:

determining a low pressure compressor rotational speed;
determining a high pressure compressor operating parameter; and
controlling a variable geometry actuator of the low pressure compressor based on the low pressure compressor rotational speed and the high pressure compressor operating parameter.

According to a third aspect of the invention there is provided a gas turbine engine comprising a compressor operating system according to the first aspect.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a sectional side view of a gas turbine engine;

FIG. 2 is a flow diagram illustrating a method of control of a compressor of the gas turbine engine of FIG. 1;

FIG. 3 is a graph showing low pressure compressor guide vane angle plotted against low pressure compressor corrected speed for first and second schedules according to the present disclosure;

FIG. 4 is a graph showing low pressure bleed valve position plotted against low pressure compressor corrected speed for first and second schedules according to the present disclosure;

FIG. 5 is a graph relating high pressure compressor pressure ratio relative to low pressure corrected speed, comparing a prior compressor control method to a compressor control method in accordance with the present disclosure;

FIG. 6 is a flow diagram illustrating an alternative method of control of a compressor of the gas turbine engine of FIG. 1; and

FIG. 7 is a graph showing low pressure compressor guide vane angle plotted against low pressure compressor corrected speed for an alternative compressor control schedule according to the present disclosure.

### DETAILED DESCRIPTION

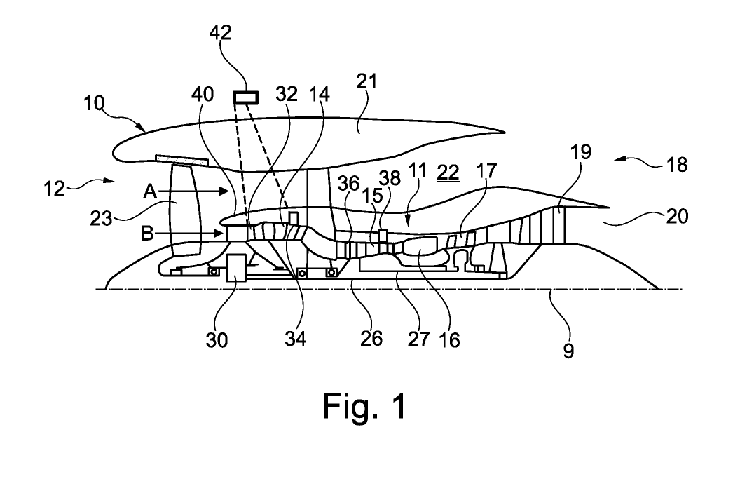

With reference to FIG. 1, a gas turbine engine is generally indicated at 10, having a principal and rotational axis 11. The engine 10 comprises, in axial flow series, an air intake 12, a propulsive fan 23, a gearbox 30, a low pressure compressor (LPC) 14, a high-pressure compressor (HPC) 15, combustion equipment 16, a high-pressure turbine 17, a low-pressure turbine 19 and an exhaust nozzle 20. A nacelle 21 generally surrounds the engine 10 and defines the intake 12.

The gas turbine engine 10 works in the conventional manner so that air entering the intake 12 is accelerated and compressed by the fan 23 to produce two air flows: a first air flow A into the engine core and a second air flow B which passes through a bypass duct 22 to provide propulsive thrust. The first and second airflows A, B split at a generally annular splitter 40, for example at the leading edge of the generally annular splitter 40 at a generally circular stagnation line.

The engine core includes the LPC 14 which compresses the air flow directed into it before delivering that air to the HPC 15 where further compression takes place.

The compressed air exhausted from the HPC 15 is directed into the combustion equipment 16 where it is mixed with fuel and the mixture combusted. The resultant hot combustion products then expand through, and thereby drive the high pressure turbine 17 and the low pressure turbine 19 before being exhausted through the nozzle 20 to provide additional propulsive thrust. The LPC 14 is driven by the low pressure turbine 19 by a low pressure shaft 26. The HPC 15 is driven by the high pressure turbine 17 by a high pressure shaft 27. The low pressure shaft 26 also drives the fan 23 via the gearbox 30. The gearbox 30 is a reduction gearbox in that it gears down the rate of rotation of the fan 23 by comparison with the low pressure compressor 14 and low pressure turbine 19. The gearbox 30 may be any suitable type of gearbox, such as an epicyclic planetary gearbox (having a static ring gear, rotating and orbiting planet gears supported by a planet carrier and a rotating sun gear) or a star gearbox. Additionally or alternatively the gearbox 30 may drive additional and/or alternative components (e.g. a further compressor).

The low and high pressure compressors 14, 15, high and low pressure turbines 17, 19, low and high pressure shafts 26, 27, and the combustor 16 may all be said to be part of the engine core.

As will be understood, the geared turbofan of FIG. 1 has different characteristics compared to “direct drive” turbofans, in which the low pressure turbine is directly coupled to the fan. Compared to a direct drive turbine, the low pressure turbine 19 and low pressure compressor 15 spin at a higher rate for a given fan 23 rotational speed. This higher rotational speed, in addition to the additional rotational mass of the rotating elements of the gearbox 30, may result in the low pressure spool (comprising the low pressure turbine 19, shaft 26, compressor 14, gearbox 30 and fan 23) to have a relatively high rotational inertia compared to direct drive engines of a similar size. On the other hand, high pressure spool (comprising the HPC 15, shaft 27 and turbine 17) is unaffected by this change. This has an effect on operability of the low and high pressure compressors 14, 15.

In particular, it has been found by the inventors that during accelerations, the HPC 15 accelerates relatively rapidly, whereas the LPC 14 accelerates relatively slowly. This results in a relatively low pressure ratio across the LPC 14 during accelerations due to two related effects. Firstly, the LPC 14 rotates relatively slowly, resulting in a low pressure ratio being developed. Secondly, the HPC 15 reaches high speeds more quickly, resulting in a relatively high pressure ratio. This high pressure ratio across the HPC 15 “sucks” air from the LPC exit, resulting in a lower pressure rise across the LPC 14, and so a low load on the LPC.

Each compressor 14, 15 comprises variable geometry actuators in the form of variable inlet guide vanes (IGVs) 32, 36, and bleed valves 34, 38. The IGVs 32, 36 are of conventional construction, and are configured to pivot about a generally radially extending axis, to adjust the angle of attack (a) of air impinging on downstream compressor rotor stages. Conventionally, the IGVs 32, 36 are located toward the front of a respective compressor 14, 15, prior to the first rotor stage, and optionally for one or more subsequent stages. The IGVs 32, 36 are moveable between an “open” position, in which a leading edge of the respective IGV 32, 36 is substantially parallel to the engine axis 9, and the angle of attack of the downstream rotor blades is relatively high, and a “closed” position, in which the leading edge is turned further toward a circumferential direction, away from the engine axis 9, and the angle of attack of the downstream rotor blades is relatively low.

Similarly, the bleed valves 34, 38 are valves, which can open to allow core air to escape from a respective compressor 14, 15, or close to keep core air within the compressor 14, 15, for further compression or combustion in downstream components. The bleed valves 34, 38 are typically located toward the rear of the compressors 14, 15. Opening of a bleed valve 34, 38, consequently typically reduces the pressure ratio of that compressor 14, 15, while closing the valve 34, 38 raises the pressure.

In a conventional turbofan engine, the IGVs 32, 36 and bleed valves 34, 38 are controlled in accordance with a compressor control schedule. The schedule takes into account current conditions of the compressor being controlled (e.g. low pressure compressor 14 rotational speed N1 for the LPC control schedule), as well as environmental conditions such as inlet temperature T24. The vanes 32, 36 and valves 34, 38 are then controlled on the basis of the current rotational speed N1, corrected for LPC 14 inlet temperature T24. Typically, the IGVs are closed at low compressor speed N1, and open at higher speeds. By closing the IGVs 32, 34 at low speeds, blade angle of attack a and mass flow W is reduced, to ensure that the compressor blades do not stall. The difference between the current pressure ratio P26/P24 of the compressor 14 and the pressure ratio P26/P24 at which the compressor will stall or surge is known as the “surge margin”. The schedule attempts to maintain the compressor ratio below the surge margin at all times, but reasonably close, so as to maintain high efficiency. Similarly, the valves 34, 38 are opened at low corrected rotational speeds N1/√T24, so that pressure ratio is similarly reduced, and closed at higher rotational speeds so that pressure ratio is increased. Typically, the bleeds have only two settings—open and closed, though variable flow bleed valves with multiple continuously variable positions between fully open and fully closed are known.

Consequently, during acceleration, in a conventional turbofan engine, the IGVs 32 of the LPC 14 are held closed, while the HPC 15 accelerates rapidly. In view of the high pressure ratio across the HPC 15 and the closed IGVs 32, the pressure ratio across the LPC 14 remains low, in spite of the increasing speed. This can cause two problems.

Firstly, mass flow downstream of the LPC 14 remains low, restricting acceleration. Secondly, due to the low pressure ratio of the LPC 14, overall pressure ratio is reduced, and so engine power and therefore acceleration is further reduced. Thirdly, the low load on the LPC 14 can result in an “overshoot”, i.e. a rapid increase in HPC 15 rotational speed. This may damage the engine.

The present disclosure provides a compressor control method and system which seeks to address one or more of the above problems.

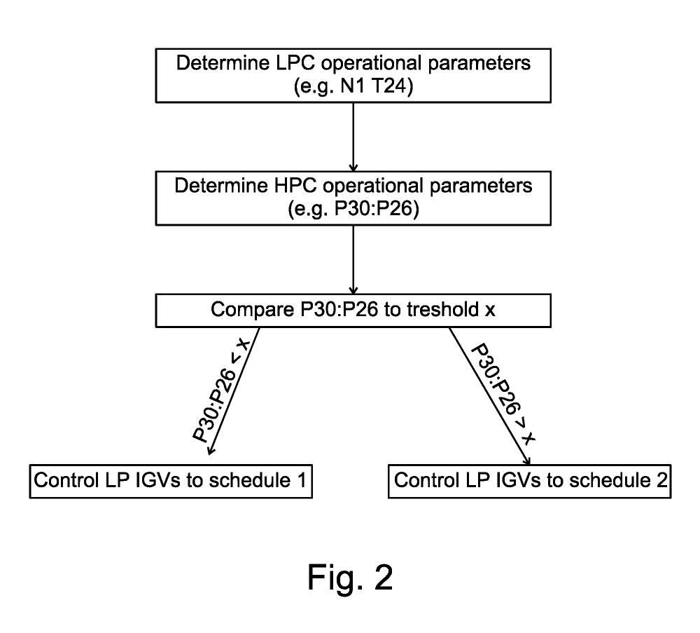

FIG. 2 shows a low pressure compressor 14 control scheme in accordance with the present disclosure, which is implemented by a controller 42. In a first step, one or more LPC 14 operational parameters are determined. In the present embodiment, the LPC 14 operational parameters comprise LPC 14 rotational speed N1 as determined by a speed sensor (not shown), and low temperature compressor 24 inlet temperature T24. The LPC 14 rotational speed N1 and low temperature compressor 24 inlet temperature T24 are used to determine a LPC 14 corrected speed N1/√T24 by dividing the rotational speed (in terms of rotations per minute or an equivalent unit) by the square root of the absolute compressor 14 inlet temperature (in terms of Kelvin or an equivalent unit).

In a second step, one or more high pressure compressor 15 operational parameters are determined. It has been found that a useful HPC 15 parameter for controlling the LPC 14 is core air mass flow rate \dot{m}. However, it may be difficult to direct determine \dot{m} in practice, and so a surrogate parameter may be measured instead, which provides an accurate indication of \dot{m} in lieu of a direct measurement.

In the present embodiment, the HPC 15 operational parameters used in lieu of \dot{m} comprise high pressure compressor 15 inlet pressure P26 and high pressure compressor outlet pressure P30. Typically, the inlet and outlet pressures are in terms of static pressure, though dynamic or total pressures could be used. These pressures may be determined directly using pressure sensors (such as pitot tubes or equivalent sensors) located in the inlet and outlet of the high pressure compressor 15 respectively. An HPC 15 pressure ratio P30:P26 is calculated dividing the outlet pressure P30 by the inlet pressure P26.

Alternative or additional alternative indications of \dot{m} include high pressure compressor 15 rotational speed N2, high pressure compressor 15 correct rotational speed N2/√T26 (i.e. the rotational speed divided by the square root of the absolute compressor 15 inlet temperature), and HP compressor VGV 36 angle. N2 and N2/√T26 have the advantage of being relatively easy to measure, are typically already measured in existing gas turbine engines, and are generally proportional to mass flow. Similarly, VGV 36 angle (either as output from a HPC VGV 36 schedule or measured from a position sensor) again provides a convenient measurement, but is potentially less accurate.

In a third step, the HPC pressure ratio P30:P26 is compared to a predetermined threshold, and a first or a second LPC 14 compressor VGV schedule is selected on the basis of the comparison. If the high pressure compressor 15 pressure ratio P30:P26 is below the threshold, the first schedule is selected, while if the pressure ratio is above the threshold, the second schedule is selected. The threshold for rising HPC pressure ratio P30:P26 may be higher than the threshold for falling HPC pressure ratio P30:P26, to prevent rapid switching back and forth between schedules where the HPC pressure ratio P30:P26 is close to a switching threshold.

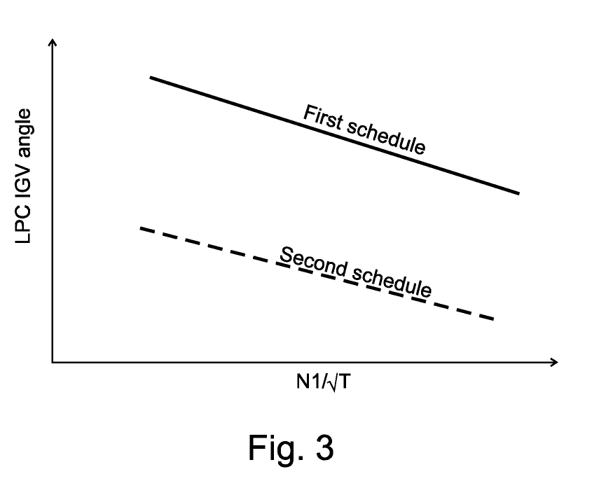

In a fourth step, the LPC 14 is controlled in accordance with the selected schedule. The control scheme incorporates one or more of the IGVs 32 and bleed valves 34. FIG. 3 shows a graph illustrating the first and second control schedules for the IGVs 32 in solid lines and dotted lines respectively.

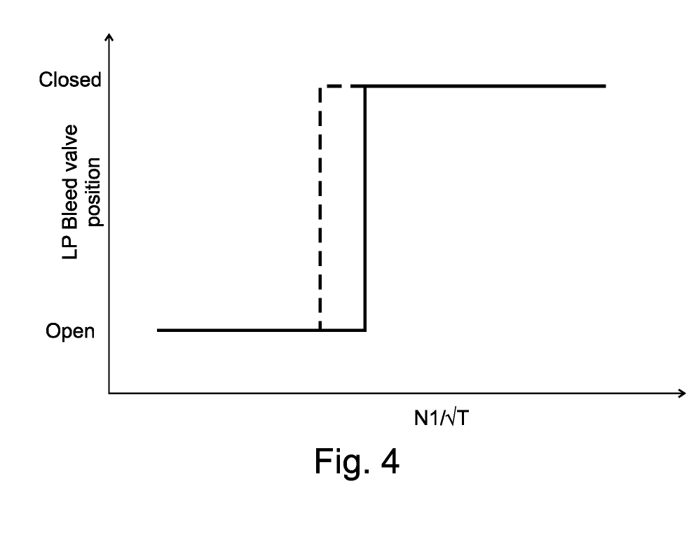

Similarly, referring to FIG. 4, a similar bleed valve 34 schedule is utilised. For both the first schedule and the second schedule, the bleed valves 34 are scheduled such that the bleed valves are open at low LPC 14 corrected speeds N1/√T24, and closed at higher speeds, as shown. However, the threshold LPC 14 corrected speed N1/√T24 at which the bleed valve is closed varies. At low HPC 15 pressure ratio P30:P26, the bleed valves 34 are operated in accordance with a first schedule (as shown by the solid line in FIG. 4), which has a threshold value such that the bleed valves 34 are opened at relatively high corrected speeds N1/√T24. On the other hand, where the high HPC 15 pressure ratio P30:P26 exceeds a predetermined threshold, the bleed valves 32 are operated in accordance with a second schedule (as shown by the dotted line in FIG. 4), which has a threshold value such that the bleed valves 34 are opened at relatively low corrected speeds N1/√T24.

First considering the first control schedule, it can be seen that IGV 32 vane angle decreases (i.e. the IGV opens) from a relatively closed position as low pressure compressor corrected speed N1/√T24 increases. This ensures that the compressor is operated relatively efficiently, while ensuring that sufficient stall margin is maintained. Typically, during an acceleration from a low engine speed (e.g. flight idle), the engine will be operated in accordance with the first schedule, as the LPC 14 and HPC 15 begin to accelerate. Consequently, at least initially, the LPC 14 is operated according to a relatively conservative compressor schedule.

On the other hand, as can be seen, in accordance with the second schedule, the IGV 32 vane angle again decreases (i.e. the IGV opens) as low pressure compressor corrected speed N1/√T24 increases. However, the second schedule has a lower IGV angle (i.e. a more open position) for a given LPC N1/√T24 value. As can be seen, the slope (i.e. the rate at which the IGVs open at increasing N1/√T24) is the same or similar, with the graph shifted downwards between the first and second schedules. In other words, a constant IGV angle is subtracted from the first schedule to produce the second schedule. Alternatively, or in addition, the slope may also vary between the first and second schedules. It will be understood that the schedules may not comprise a constant slope, but may comprise a complex curve.

Consequently, the LPC 14 is controlled in operation as follows. Starting from flight idle, both the LPC 14 and HPC 14 have relatively low rotational speeds N1, N2. As the engine accelerates, both compressors 14, 15 accelerate toward higher speeds. As the mass flow rate \dot{m} through the HPC 15 is initially low, as indicated by the low pressure ratio P30:P26 across the HPC, the LPC 14 is operated in accordance with the first schedule. However, the HPC rapidly accelerates, thereby increasing the mass flow rate \dot{m} and pressure ratio P30:P26 across the HPC. Consequently, the controller switches control of the IGVs to the second schedule, thereby reducing IGV vane angle, and increasing pressure ratio across the LPC 14, which in turn increases load on the LPC 14. Consequently, the engine is able to accelerate more quickly. Additionally, the increasing load on the LPC 14 in view of the reduced vane angle prevents excessive HPC 15 rotational speed increase, and so prevents HPC 15 runaway during acceleration.

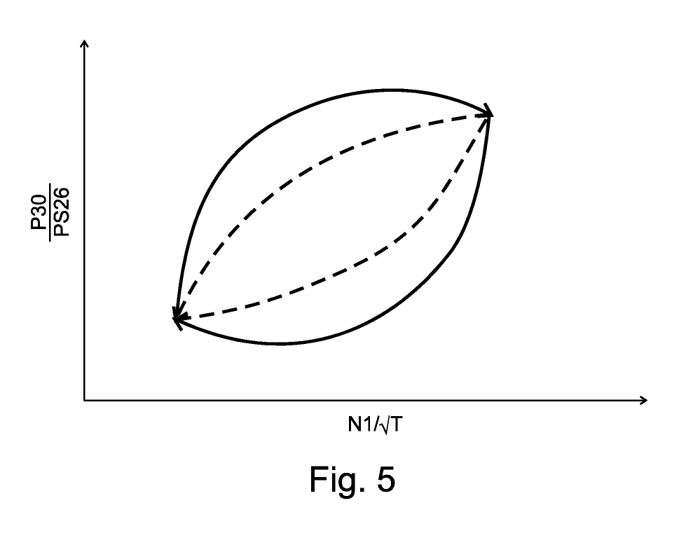

Referring now to FIG. 5, the effect of the new method of operation on the high pressure compressor can be shown. The solid lines represent acceleration and deceleration of the engine from idle to maximum take-off thrust. As can be seen, the HPC compressor 15 ratio “overshoots”, i.e. exceeds a desired maximum during acceleration, before reducing once more. This may cause surges or damage to the engine. On the other-hand, the pressure ratio falls below a desired minimum during declaration, which may result in unstable combustion in the combustor and/or “flameout”, i.e. shutdown of the engine. In contrast, the control method of the current disclose (shown in dotted lines) results in a smooth acceleration of high pressure compressor pressure ratio as the engine accelerations, and also a smooth deceleration, with no overshoots.

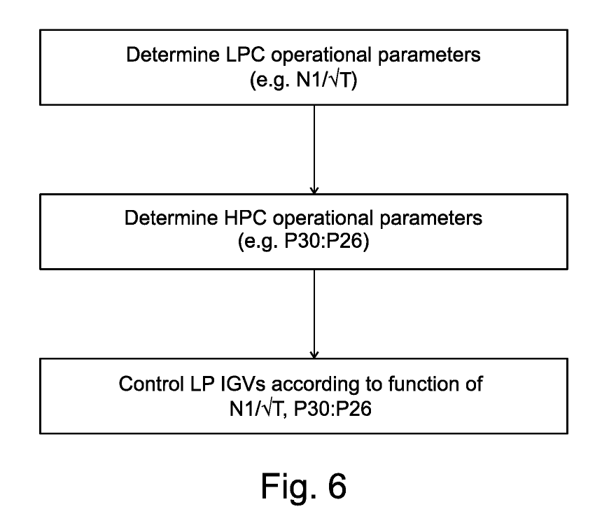

Referring now to FIG. 6, an alternative control scheme in accordance with the present disclosure is shown.

In first and second steps, low and high pressure compressor 14, 15 operational parameters (N1/√T and P30:P26 respectively in this example) are again determined, in a similar manner to the first and second steps of the first embodiment. Again, alternative operational parameters as disclosed for the first embodiment could be utilised.

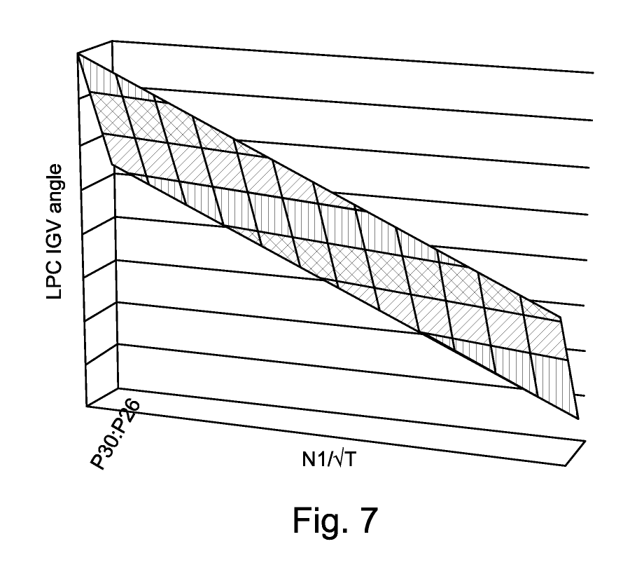

In a third step, an LPC 14 VGV 36 position is calculated according to a schedule that takes into account both LPC 14 rotational speed N1/√T and HPC 15 compressor ratio P30:P26. As can be seen in FIG. 7, IGV angle decreases on the basis of increased N1/√T, similarly to the first and second schedules of the first embodiment. However, in addition, IGV angle also decreases as HPC 15 compressor ratio P30:P26 increases. Essentially therefore, a “correction factor” is applied to the schedule based on N1/√T, with the IGV 36 vane angle reducing proportionate to P30:P26 increase. Consequently, finer control on the basis of HPC 15 mass flow \dot{m} is achieved.

A similar approach could again be used for LP bleed valve 34 operation, with the bleed valve 34 opening threshold N1/√T being determined on the basis of HPC 15 pressure ratio P30:P26, with higher pressure ratios generally leading to a lower bleed valve opening threshold N1/√T. Where the bleed valve 34 is variable (i.e. has more than two positions), the extent of opening may be varied in relation to the HPC 15 pressure ratio, with higher ratios leading to a more closed position for a given N1/√T.

Consequently, in many cases, lower IGV angles (i.e. more open IGVs) can be utilised, thereby increasing mass flow through the engine, as well as increasing LPC 14 compressor load. Consequently, HP compressor runaway is prevented, and compressor mass flow is increased, leading to increased acceleration without risking compressor stall or surge. Similarly, the bleed valves 34 can be closed for a large range of LPC 14 operating conditions.

Such a method is particularly, though not exclusively, suitable for geared turbofans, where the LPC, low pressure turbine, reduction gearbox and fan are located on the same shaft.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A gas turbine engine compressor operating system, the gas turbine engine (10) comprising:
a low pressure compressor (14) and a high pressure compressor (15), the low and high pressure compressors (14, 15) being driven by low and high pressure shafts (26, 27) respectively, the high pressure compressor (15) being provided downstream in core mass flow of the low pressure compressor (14); the compressor operating system comprising:
a controller (42) configured to control a variable geometry actuator (32, 34) of the low pressure compressor (14), the controller (42) being configured to control the variable geometry actuator (32, 34) on the basis of low pressure compressor (14) rotational speed (N1) and a high pressure compressor operating parameter.

2. A compressor operating system according to claim 1, wherein the low pressure compressor (14) rotational speed comprises a corrected low pressure compressor rotational speed (N1/√T24).

3. A compressor operating system according to claim 1, wherein the high pressure compressor (15) operating parameter comprises one or more of high pressure compressor mass flow rate \dot{m}, high pressure compressor pressure ratio (P30:P26), high pressure compressor rotational speed (N2), high pressure compressor corrected rotational speed (N2/√T26), and high pressure compressor variable inlet guide vane angle (α).

4. A compressor operating system according to claim 1, wherein the gas turbine engine (10) comprises a geared turbofan comprising a fan (23) coupled to an output of a reduction gearbox (30).

5. A compressor operating system according to claim 4, wherein an input of the reduction gearbox (30) is coupled to the low pressure shaft (26), and a low pressure turbine (19) is coupled to the low pressure shaft (26).

6. A compressor operating system according to claim 1, wherein the variable geometry actuator comprises one or both of a variable inlet guide vane (32) and a bleed valve (34).

7. A compressor operating system according to claim 6, the second schedule comprises a more open inlet guide vane (32) position for a given low pressure compressor (14) rotational speed than the first schedule.

8. A compressor operating system according to claim 6, wherein the second schedule comprises a more closed bleed valve (34) position for a given low pressure compressor (14) rotational speed than the first schedule.

9. A compressor operating system according to claim 1, wherein the controller (42) is configured to operate the low pressure compressor (14) on the basis of one of a first schedule and a second schedule in accordance with the high pressure compressor (15) operating parameter.

10. A compressor operating system according to claim 9, wherein the low pressure compressor (14) is operated in accordance with the first schedule where the high pressure compressor (15) is at a relatively low pressure ratio, and is operated in accordance with the second schedule where the high pressure compressor (15) is at a relatively high pressure ratio.

11. A compressor operating system according to claim 10, the second schedule comprises a more open inlet guide vane (32) position for a given low pressure compressor (14) rotational speed than the first schedule.

12. A compressor operating system according to claim 10, wherein the second schedule comprises a more closed bleed valve (34) position for a given low pressure compressor (14) rotational speed than the first schedule.

13. A compressor operating system according to claim 1, wherein the controller (42) is configured to determine a correction factor to the low pressure compressor (14) control schedule based on the high pressure compressor parameter.

14. A compressor operating system according to claim 13, wherein the correction factor is proportional to one or more of the high pressure compressor mass flow (\dot{m}), the high pressure compressor pressure ratio (P30:P26), or a parameter indicative of the high pressure compressor pressure ratio.

15. A method of controlling a gas turbine engine compressor (14) of a gas turbine engine (10), the engine (10) comprising:
a low pressure compressor (14) and a high pressure compressor (14), the low and high pressure compressors (14, 15) being driven by low and high pressure shafts respectively (26, 27), the high pressure compressor (15) being provided downstream in core mass flow of the low pressure compressor (14); the method comprising:
determining a low pressure compressor (14) rotational speed (N1);
determining a high pressure compressor operating parameter; and
controlling a variable geometry actuator (32, 34) of the low pressure compressor (14) based on the low pressure compressor (14) rotational speed (N1) and the high pressure compressor (15) operating parameter.

16. A gas turbine engine (10) comprising a compressor operating system according to claim 1.
